(19) United States
(12) Patent Application Publication
(10) Pub. No.: US 2013/0069384 A1
(43) Pub. Date: Mar. 21, 2013

(54) AUTOMOBILE BODY

(71) Applicants: Vladimir Vitalievich Miroshnichenko, Ljubertsi (RU); Vitaly Evgenievich Pilkin, Moscow (RU)

(72) Inventors: Vladimir Vitalievich Miroshnichenko, Ljubertsi (RU); Vitaly Evgenievich Pilkin, Moscow (RU)

(21) Appl. No.: 13/695,484

(22) PCT Filed: May 17, 2011
(86) PCT No.: PCT/RU11/00332

§ 371 Date: Oct. 31, 2012

(30) Foreign Application Priority Data
Jun. 9, 2010 (RU) 2010123434

(51) Int. Cl. B60R 16/00

(52) U.S. Cl. CPC B60R 16/00
USPC 296/1.01

(57) ABSTRACT

The invention is intended to expand the possibility of access to automobile technical means, placed wholly or partially on the outer surface of the automobile body. The automobile body includes at least one technical mean, placed wholly or partially on the outer surface of the automobile body, herewith an access to specified technical mean or technical means are provided from the exterior of the automobile, herewith the technical means are at least one car cigarette lighter socket, at least one USB-connector, at least one adapter, completely or partially touch screen display, non-touch screen display, at least one touchpad, at least one joystick, at least one trackball, at least one headphone, at least one headset communication device, at least one measuring device, at least one scanner, at least one storage media, at least one remote control device, communication device to connect with the mobile communication device, Bluetooth.

### CROSS-REFERENCE TO RELATED APPLICATIONS

This application is a U.S. national stage application of the PCT application PCT/RU2011/000332 filed on 17 May 2011, published as WO 2011/155870, whose disclosure is incorporated herein in its entirety by reference, which PCT application claims priority of a Russian Federation application RU20101123434 filed on 9 Jun. 2010.

### FIELD OF THE INVENTION

The invention relates to the automobile body and is intended to expand the possibility of access to automobile technical means, placed wholly or partially on the outer surface of the automobile body.

### BACKGROUND OF THE INVENTION

There are known technical means of automobile, which are placed inside the automobile. For example, automobile cigarette lighter is located in the automobile cabin. For details, see http://en.wikipedia.org/wiki/Cigarette lighter receptacle. In order to connect an electrical device to the cigarette lighter, for example, the electropump, it is necessary to open the automobile door to stretch out an electricity cable on outer side of automobile body for pumping automobile wheels. This is not always convenient when it is cold outside, and there are people inside the automobile cabin.

The claimer has failed to find in accessible information sources technical solutions that could be considered as a prototype of the claimed invention.

### DESCRIPTION OF THE INVENTION

The task to be solved and the technical result of the claimed invention is to expand the possibility of access to automobile technical means placed wholly or partially on the outer surface of the automobile body. By the automobile technical means are understood car cigarette lighter socket, USB-connector, adapter, completely or partially touch screen display, non-touch screen display, touchpad, joystick, trackball, headphone, headset communication device, measuring device, scanner, storage media, remote control device, communication device to connect with the mobile communication device, Bluetooth.

With a view of correct understanding and interpretation of used in the present invention terms the following terminology was used:

An access to the technical means from the exterior of the automobile is the feasibility of manual or radioelectronic manipulations of technical means, placed wholly or in part on the outer surface of the automobile body, from the exterior of the automobile. For example, by technical mean allocation wholly or partially on the outer surface of the automobile body is understood the technical mean allocation on the surface or inside of the automobile body, with access to specified technical mean from the exterior of the automobile.

The exterior of the automobile is the space outside the interior of the automobile.

The automobile body is the part of the automobile designed to accommodate passengers and cargo. The automobile body is mounted to the automobile frame. There is also frameless automobile body performing also a function of frame. All other automobile components and assemblies are attached to the said frameless automobile body.

The specified technical result is achieved as follows:

An automobile body includes at least one technical mean, placed wholly or partially on the outer surface of the automobile body, herewith an access to specified technical mean or technical means are provided from the exterior of the automobile, herewith the technical means are at least one car cigarette lighter socket, at least one USB-connector, at least one adapter, completely or partially touch screen display, non-touch screen display, at least one touchpad, at least one joystick, at least one trackball, at least one headphone, at least one headset communication device, at least one measuring device, at least one scanner, at least one storage media, at least one remote control device, communication device to connect with the mobile communication device, Bluetooth (hereinafter above technical means are referred to as “the technical mean or technical means”).

At least one specified technical mean can be connected with at least one technical mean of the automobile by wire and/or wireless connection methods.

Visual display, or touchpad, or joystick, or trackball, or remote control device, or communication device to connect with the mobile communication device can be used to control at least one automobile technical mean and/or to control at least one technical mean connected with the automobile.

All or a part or one of the specified technical means can be located under the protecting cover, which protects all or a part or one of the specified technical means against environmental factors and/or against unauthorized access to all or a part or one of the specified technical means.

The specified protecting cover or a part of specified protecting cover can be transparent or semitransparent or non-transparent or can be performed under the color of automobile body.

On specified protecting cover and/or under specified protecting cover can be placed lighting, which is switched on at opening specified protecting cover.

At least one specified technical mean may be removable or not removable.

For operation with at least one of specified technical means it can be moved in whole or in part on the surface or outside surface of the automobile body.

At least one of specified technical means can be automatically switched off if automobile battery level is insufficient and/or it threatens to bring down specified battery.

If automobile battery level is insufficient and/or threatens to bring down specified battery, it can be given sound and/or radio and/or light warning signal.

At least one of specified technical means can have an autonomous power supply.

At least one specified technical mean can be accessed from the outside of automobile body.

An access to at least one of specified technical means can be provided outside of hood, or outside of side bar, or outside of door of the automobile, or outside of automobile trunk lid, or outside of head of automobile body, or outside of automobile front wing, or outside of automobile rear wing, or outside of rear-view mirror housing, or outside of bumper of the automobile, or outside of bottom of the automobile, or outside of automobile windshield, or outside of door window glass of the automobile, or outside of side surface of automobile body.

The surface on which specified technical means are placed is made wholly or partially of composite material or composite materials.

### EMBODIMENT OF THE INVENTION

The claimed invention is technically feasible as technological tools, components and materials that allow implementing the claimed invention are known in the background art.

Significant features of the invention, expressed in the section “Description of the invention” as an alternative for any choice permitted by this alternative in conjunction with other features characterizing the invention provide receiving the same technical result, which is to expand the possibility of access to automobile technical means, placed wholly or partially on the outer surface of the automobile body.

### APPLICATIONS OF THE INVENTION

The claimed technical solution can be applied in automobile body in order to provide an access to the automobile technical means, placed wholly or partially on the outer surface of the automobile body, from the exterior of the automobile.

1. An automobile body, wherein automobile body includes at least one technical mean, placed wholly or partially on the outer surface of the automobile body, herewith an access to specified technical mean or technical means are provided from the exterior of the automobile, herewith the technical means are at least one car cigarette lighter socket, at least one USB-connector, at least one adapter, completely or partially touch screen display, non-touch screen display, at least one touchpad, at least one joystick, at least one trackball, at least one headphone, at least one headset communication device, at least one measuring device, at least one scanner, at least one storage media, at least one remote control device, communication device to connect with the mobile communication device, Bluetooth (hereinafter above technical means are referred to as “the technical mean or technical means”).

2. The automobile body according to claim 1, wherein at least one specified technical mean is connected with at least one technical mean of the automobile by wire and/or wireless connection methods.

3. The automobile body according to claim 1, wherein visual display, or touchpad, or joystick, or trackball, or remote control device, or communication device to connect with the mobile communication device is used to control at least one automobile technical mean and/or to control at least one technical mean connected with the automobile.

4. The automobile body according to claim 1, wherein all or a part or one of the specified technical means are located under the protecting cover, which protects all or a part or one of the specified technical means against environmental factors and/or against unauthorized access to all or a part or one of the specified technical means.

5. The automobile body according to claim 4, wherein the specified protecting cover or a part of specified protecting cover is transparent or semitransparent or non-transparent or is performed under the color of automobile body.

6. The automobile body according to claim 4, wherein on specified protecting cover and/or under specified protecting cover is placed lighting, which is switched on at opening specified protecting cover.

7. The automobile body according to claim 1, wherein at least one specified technical mean is removable or not removable.

8. The automobile body according to claim 1, wherein for operation with at least one of specified technical means it is moved in whole or in part on the surface or outside surface of the automobile body.

9. The automobile body according to claim 1, wherein at least one of specified technical means is automatically switched off if automobile battery level is insufficient and/or it threatens to bring down specified battery.

10. The automobile body according to claim 1, wherein if automobile battery level is insufficient and/or threatens to bring down specified battery, it is given sound and/or radio and/or light warning signal.

11. The automobile body according to claim 1, wherein at least one of specified technical means has an autonomous power supply.

12. The automobile body according to claim 1, wherein at least one specified technical mean is accessed from the outside of automobile body.

13. The automobile body according to claim 12, wherein access to at least one of specified technical means is provided outside of hood, or outside of side bar, or outside of door of the automobile, or outside of automobile trunk lid, or outside of head of automobile body, or outside of automobile front wing, or outside of automobile rear wing, or outside of rear-view mirror housing, or outside of bumper of the automobile, or outside of bottom of the automobile, or outside of automobile windshield, or outside of door window glass of the automobile, or outside of side surface of automobile body.

14. The automobile body according to claim 1, wherein the surface on which specified technical means are placed is made wholly or partially of composite material or composite materials.

15-19. (canceled)
